(19) United States
(12) Patent Application Publication
(10) Pub. No.: US 2021/0188538 A1
(43) Pub. Date: Jun. 24, 2021

(54) Multiport Thief Hatch for Storage Tank

(71) Applicant: Baker Hughes Oilfield Operations LLC, Houston, TX (US)

(72) Inventors: Sam Stroder, Edmond, OK (US); Melissa Allin, Oklahoma City, OK (US)

(73) Assignee: Baker Hughes Oilfield Operations LLC, Houston, TX (US)

(21) Appl. No.: 16/724,255

(22) Filed: Dec. 21, 2019

(51) Int. Cl. B65D 90/34; B65D 88/08; B65D 90/48; B65D 90/10; G08B 21/18; G01L 19/08; G01L 19/12

(52) U.S. Cl. CPC B65D 90/34; B65D 88/08; B65D 90/48; G01L 19/12; G08B 21/182; G01L 19/086; B65D 90/10

(57) ABSTRACT

A multifunction tank access device is configured for connection to a storage tank capable of storing crude oil that has an opening for a conventional thief hatch. The multifunction tank access device has a lower assembly with an isolation valve, and an upper assembly removably connected to the lower assembly. The upper assembly includes a central housing, a pressure relief module, a vacuum relief module, and a tank access module. In some embodiments, at least a portion of the multifunction tank access device is constructed from a material that melts at a temperature below 450° F.

### FIELD OF THE INVENTION

This invention relates generally to systems used in connection with storage tanks configured to liquid hydrocarbons or other potentially hazardous fluids.

### BACKGROUND

Crude oil and other petroleum hydrocarbons produced from oil and gas wells are often temporarily stored in tanks that are located near the well. These tanks are sometimes referred to as “stock” tanks and multiple tanks may be arranged in “tank batteries.” The hydrocarbon products can be transported from the storage tanks to a transport terminal, pipeline or refinery in a tanker truck. The oil is routinely measured and tested at the storage tank. In many cases, the crude oil in the storage tank is tested by opening a door on the lid of the tank often referred to as the “thief hatch.” Opening the thief hatch permits the operator to take measurements to determine the volume of hydrocarbon liquids in the tank, the position of the interface between oil and water liquids, and the quality of the crude oil in the tank.

Because crude oil and other hydrocarbons may present personal safety and environmental risks, it is important to properly contain the hydrocarbons within the storage tank, while permitting the assessment of the quantity and quality of those hydrocarbons. In particular, the loss of hydrocarbon gases to the atmosphere may present an environmental emission, a safety risk, and a loss of revenue. At storage tank batteries, the separation, containment and collection of low-pressure hydrocarbon vapors depends on multiple pressure controls on the near-atmospheric storage tanks. Those controls are sequentially set and maintained at graduated settings of very low pressure (often in ounces/square inch).

Hydrocarbon fluids may offgas while captured in the storage tank, thereby potentially increasing the pressure of gases trapped in the headspace above the liquid. Additionally, the gas pressures inside the storage tank may fluctuate with changes in environmental temperatures surrounding the storage tank. The proper design of a tank vapor management system requires the incorporation of tank outbreathing and inbreathing protection through pressure/vacuum relief valves (PVRVs) to accommodate changes in internal pressures, as well as high volume venting for fire sizing. Each incorporated PVRV usually requires its own dedicated tank connection, and all added devices must be setpoint-integrated with one another and the aforementioned graduated tank pressure controls to ensure that the entire system vents when, but only when, necessary.

Newly constructed tanks can be designed to accommodate the venting requirements by equipping the tanks with PVRV connections initially, but at incremental expense. This, however, does not eliminate the use of the conventional thief hatch and the fugitive emissions of greenhouse gases (GHG), hazardous air pollutants (HAPs) and other volatile organic compounds (VOCs) that may leak at problematic rates from the thief hatch. For many storage tanks already in operation, however, there is a lack of the necessary pressure/vacuum controls and inbreathing/outbreathing is typically performed by pulling air in from, and venting harmful vapors out to, the atmosphere via the thief hatch. With existing thief hatches, there is no way to easily ascertain if the thief hatch or another port on the storage tank has begun to leak and is in need of repair or replacement. In view of these deficiencies, there is a need for an improved system for safely accommodating variations in pressure within the storage tank, while providing a mechanism for safely measuring the volume and quality of fluids in the storage tank.

### SUMMARY OF THE INVENTION

In one aspect, embodiments of the present invention include a multifunction tank access device configured for connection to a storage tank capable of storing crude oil that has an opening for a conventional thief hatch. The multifunction tank access device has a lower assembly with an isolation valve, and an upper assembly removably connected to the lower assembly. The upper assembly includes a central housing, a pressure relief module, a vacuum relief module, and a tank access module.

Some embodiments include a multifunction tank access device configured for connection to a storage tank capable of storing crude oil, where the storage tank has an opening for a conventional thief hatch. The multifunction tank access device has a lower assembly that includes a tank mounting flange configured for attachment to the opening for the conventional thief hatch. The multifunction tank access device further includes an upper assembly removably connected to the lower assembly, where the upper assembly comprises a central housing. In these embodiments, at least a portion of the multifunction tank access device is constructed from a material that melts at a temperature below about 450° F.

In yet other embodiments, a multifunction tank access device is configured for connection to a storage tank capable of storing crude oil. The multifunction tank access device has a lower assembly with an isolation valve, and an upper assembly removably connected to the lower assembly. The upper assembly includes a central housing, a pressure relief module, a vacuum relief module, and a tank access module. The pressure relief module has pressure relief valve that is configured to open in response to a pressure inside the central housing that exceeds a setpoint pressure established for the pressure relief valve. Similarly, the vacuum relief module has a vacuum relief valve that is configured to open in response to a vacuum inside the central housing. In these embodiments, the tank access module includes a vapor control valve that permits the safe measurement of liquids contained within the storage tank.

### BRIEF DESCRIPTION OF THE DRAWINGS

FIG. 1 depicts a storage tank and a multifunction tank access device.

FIG. 2 is a close-up perspective view of an exemplary embodiment of the multifunction tank access device of FIG. 1.

FIG. 3 is a side cross-sectional view of the multifunction tank access device of FIG. 2.

### WRITTEN DESCRIPTION

In broad terms, exemplary embodiments provide a multifunction tank access device 100 that replaces the standard tank thief hatch found on existing storage tanks. The multifunction tank access device 100 provides mechanisms for managing accumulating pressures and vacuums inside the storage tank, while also providing a mechanism for allowing an operator to safely and accurately measure and evaluate the fluids stored inside the tank. In some embodiments, the multifunction tank access device 100 is constructed primarily from a composite material with a melting point less than 450° F. In the event of a fire inside the tank, the multifunction tank access device 100 quickly melts to provide a larger port for relieving combustion gases. It will be appreciated that the multifunction tank access device 100 can be retrofitted onto existing storage tanks or provisioned on new storage tanks during the manufacturing or construction process.

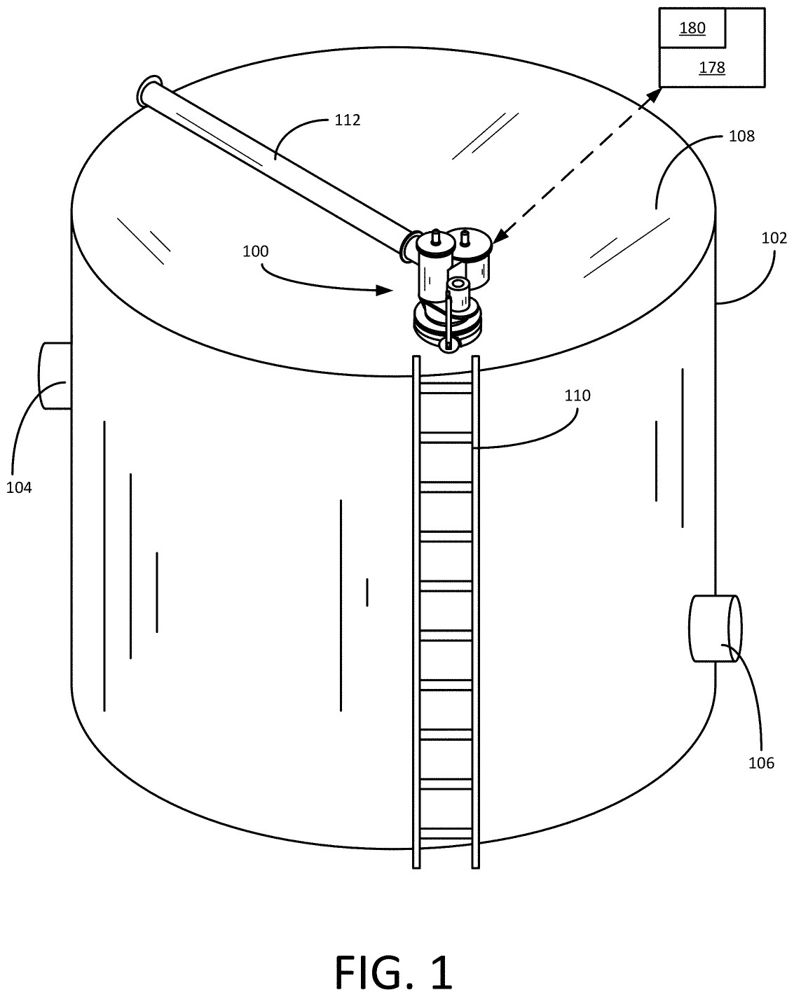

With reference to FIG. 1, shown therein is the multifunction tank access device 100 installed on a storage tank 102. The storage tank 102 is configured to primarily store liquid hydrocarbons (e.g., crude oil) and mixtures of hydrocarbons, water and other liquids. The storage tank 102 may include one or more inlets 104 and one or more outlets 106. The storage tank 102 may be standalone or positioned within a tank battery that includes a plurality of storage tanks 102. The storage tank 102 is generally cylindrical and manufactured from a corrosion-resistant metal or composite material. The storage tank 102 includes a top 108 and a catwalk or ladder 110 that provides access to the top 108.

As depicted in FIG. 1, a vapor recovery line 112 is connected to the multifunction tank access device 100. The vapor recovery line 112 conveys vapors released from the storage tank 102 to a vapor recovery unit, flare or other downstream facility (not shown). Recovered vapor products can be condensed for further processing in accordance with well-established industry practices.

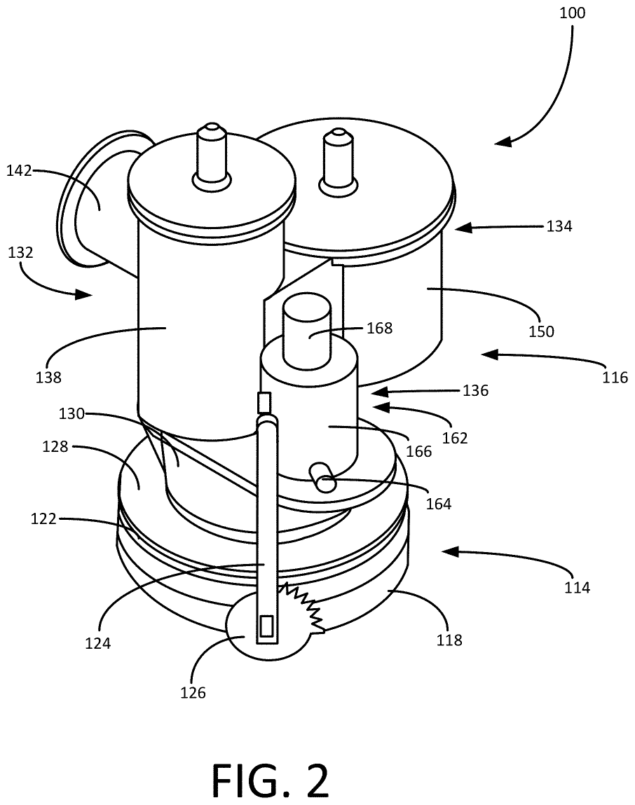

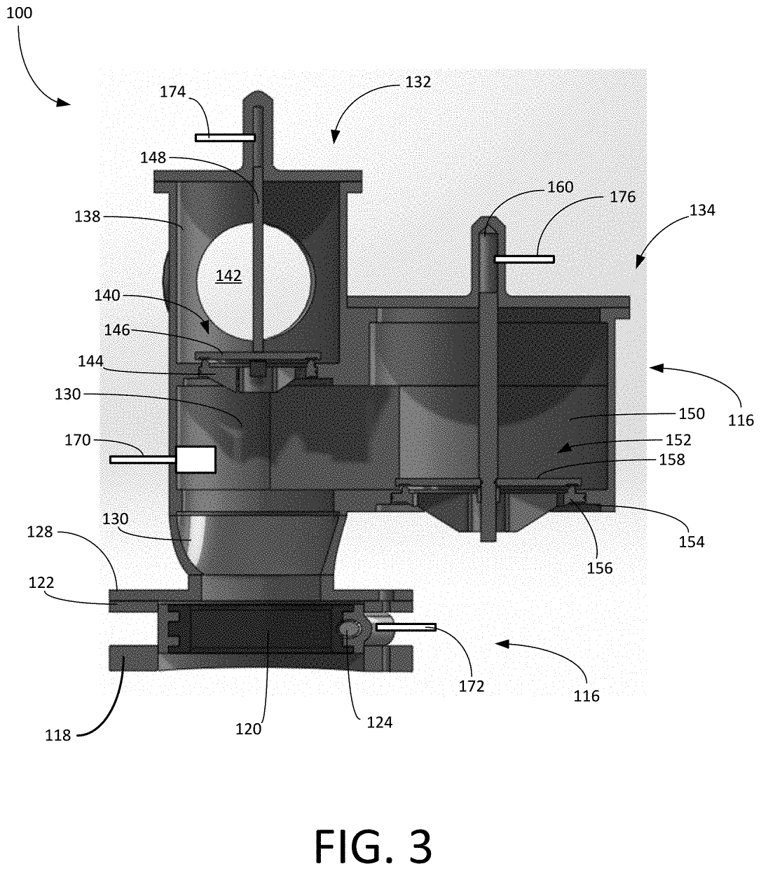

Turning to FIGS. 2 and 3, shown therein a perspective and cross-sectional views, respectively, or the multifunction tank access device 100 constructed in accordance with an exemplary, non-limiting, embodiment. The multifunction tank access device 100 includes a lower assembly 114 and an upper assembly 116.

The lower assembly 114 includes a tank mounting flange 118 that is configured to be securely fastened to the top 108 of the storage tank 102 with bolts or other fasteners. In retrofit applications, the tank mounting flange 118 can be configured with a bolt pattern that matches the existing thief hatch mounting pattern. In this way, the tank mounting flange 118 can be easily secured to the top 108 of the storage tank 102 once the thief hatch has been removed. The tank mounting flange 118 can be constructed from a durable metal or composite with sufficient strength to withstand the compressive force applied by the bolts or other fasteners used to secure the multifunction tank access device 100 to the storage tank 102.

The lower assembly 114 further includes an isolation valve 120 and an upper flange 122. In the embodiment depicted in FIGS. 2 and 3, the isolation valve 120 is a butterfly valve that can be manually actuated with an external valve lever 124. The valve lever 124 includes a position lock 126 that allows the operator to secure the isolation valve 120 in a fully closed or fully open position. In other embodiments, the isolation valve 120 is motorized and configured for automated actuation in response to a control signal.

When the isolation valve 120 is closed, the isolation valve 120 substantially seals that interior of the storage tank 102 and prevents vapors, gases or fluids from escaping through the multifunction tank access device 100. Closing the isolation valve 120 permits the upper assembly 116 to be removed or serviced without exposure to gases or fluids inside the storage tank 102. When the isolation valve 120 is opened, the interior of the upper assembly 116 of the multifunction tank access device 100 is placed in communication with the interior of the storage tank 102.

The upper assembly 116 includes base flange 128 that can be secured to the upper flange 122 of the lower assembly 114 with bolts or other fasteners. In the embodiments depicted in FIGS. 2 and 3, the upper assembly 116 includes a central housing 130, a pressure relief module 132, a vacuum relief module 134 and a tank access module 136. In some embodiments, the pressure relief module 132, the vacuum relief module 134 and the tank access module 136 are each connected to the central housing 130 in fluid communication. In this way, the central housing 130 acts as a plenum or manifold that communicates pressure from the interior of the storage tank 102 to the pressure relief module 132, a vacuum relief module 134 and a tank access module 136.

The pressure relief module 132 includes a pressure relief module housing 138, a pressure relief valve 140 and a pressure release port 142. In some embodiments, the pressure relief valve 140 is a mechanical valve that includes a pressure relief valve seat 144 and a pressure relief valve plunger 146. The pressure relief valve plunger 146 is held in a closed position against the pressure relief valve seat 144 by a pressure relief valve biasing element 148. In some embodiments, the pressure relief valve biasing element 148 is a weight-based system in which one or more weights are placed on the pressure relief valve plunger 146 to bias the pressure relief valve plunger 146 in a closed position against the pressure relief valve seat 144. In other embodiments, the pressure relief valve biasing element 148 is a spring-based system in which a spring biases the pressure relief valve plunger 146 against the vacuum relief valve seat 144. In each embodiment, the closing force can be adjusted to a desired setpoint opening force.

When the pressure of fluids inside the central housing 130 below the pressure relief module 132 exceeds the setpoint opening force, the pressure relief valve plunger 146 is forced off of the pressure relief valve seat 144 to vent excess pressure from the storage tank 102. The pressurized gases are discharged from the pressure relief valve 140 through the pressure relief port 142 to the vapor recovery line 112. In some embodiments, the discharged gases can be collected for further processing or directed to a flare for combustion.

The vacuum relief module 134 includes a vacuum relief module housing 150, a vacuum relief valve 152 and a vacuum relief port 154. The vacuum relief module housing 150 is connected to, and in fluid communication with, the central housing 130. The vacuum relief valve 152 includes a vacuum relief valve seat 156, a vacuum relief valve plunger 158 and a vacuum relief valve biasing element 160. The vacuum relief valve plunger 158 is held in a closed position against the vacuum relief valve seat 156 by a vacuum relief valve biasing element 160. In some embodiments, the vacuum relief valve biasing element 160 is a weight-based system in which one or more weights are placed on the vacuum relief valve plunger 158 to bias the vacuum relief valve plunger 158 in a closed position against the vacuum relief valve seat 156. In other embodiments, the vacuum relief valve biasing element 160 is a spring-based system in which a spring biases the vacuum relief valve plunger 158 against the vacuum relief valve seat 156. In each embodiment, the closing force can be adjusted to a desired setpoint opening force.

When a vacuum is present inside the storage tank 102, the negative pressure is communicated to the interior of the vacuum relief module housing 150 directly or indirectly through the central housing 130. When the pressure gradient across the vacuum relief valve plunger 158 exceeds the closing force applied by the vacuum relief valve biasing element 160, the vacuum relief valve plunger 158 is forced off the vacuum relief valve seat 156 to allow air or other makeup gas to enter the vacuum relief valve 152 through the vacuum relief port 154 to reduce the vacuum drawn by the storage tank 102.

Once the pressure gradient across the vacuum relief valve 152 is sufficiently mitigated, the vacuum relief valve biasing element 160 forces the vacuum relief valve plunger 158 back against the vacuum relief valve seat 156 to prevent gases in the storage tank 102 from escaping through the vacuum relief valve 152. As used herein, the terms “vacuum” or “negative pressure” refer to a pressure that is less than the atmospheric pressure surrounding the storage tank 102.

In addition to accommodating the routine expansion and contraction of gases inside the storage tank 102, the multifunction tank access device 100 also provides a mechanism for releasing rapidly expanding pressurized gases created during a combustion event inside the storage tank 102. The multifunction tank access device 100 can be partially or entirely constructed from a composite material that melts when exposed to gases produced by a combustion event. In this way, the multifunction tank access device 100 is configured to sacrificially melt in the presence of combustion gas temperatures to provide a large open vent that rapidly releases the pressurized gases inside the storage tank 102 to prevent an explosion. In this way, the cross-sectional area of the open isolation valve 120 provides an auxiliary emergency vent to improve the “fire sizing” of the storage tank 102 when the multifunction tank access device 100 is sacrificed during a combustion event.

In exemplary embodiments, one or more of the central housing 130, the pressure relief module housing 138 and the vacuum relief module housing 150 are constructed from a sacrificial material that melts at a temperature less than 450° F. Suitable materials of construction include polymers, resin-impregnated fiberglass, and low melt point metals, such as Babbitt alloys and other white metals. Suitable polymers may include polyethylene, nylons, poly(vinyl chlorides), poly(ethylene oxide), poly(propylene), and poly(ethylene adipate). For non-metal, non-conductive materials, a grounding strap can be included from the multifunction tank access device 100 to the storage tank 102.

The multifunction tank access device 100 also provides a safe and reliable mechanism for checking the volume of fluids inside the storage tank 102. The tank access module 136 includes a vapor control valve 162 that permits the use of a measuring tape without exposing the operator to gases inside the storage tank 102. In exemplary embodiments, the vapor control valve 162 includes a closing valve 164, a loading spool 166 and a removable cap 168. The closing valve 164 and isolation valve 120 can be closed to isolate the loading spool 166 from the central housing 130. The cap 168 can then be removed to allow the hermetically sealed connection of a tape or other measurement device to the top of the loading spool 166. Once connected, the closing valve 164 and isolation valve 120 can be opened to permit the tape or other measuring device to extend through the multifunction tank access device 100 into the storage tank 100, without exposing the operator to gases that would otherwise escape by taking measurements through a conventional thief hatch. Suitable vapor control valves are commercially available from a variety of sources, including MMC International Corporation.

The multifunction tank access device 100 optionally includes a plurality of sensors that are configured to monitor and report the state and condition of the multifunction tank access device 100. An internal pressure sensor 170 inside the central housing 130 reports the instantaneous and continuous pressure inside the central housing 130. The isolation valve 120 includes an isolation valve position sensor 172 that reports the extent to which the isolation valve 120 is opened or closed. The pressure relief module 132 includes a pressure relief valve position sensor 174 that monitors and reports the position of the pressure relief valve 140 to indicate whether the pressure relief valve 140 has been actuated. Similarly, the vacuum relief module 134 includes a vacuum relief valve position sensor 176 to detect and report the actuation of the vacuum relief valve 152.

Additional sensors may be incorporated within the multifunction tank access device 100 to detect the presence of hazardous gases in the tank access module 136 to alert the operator to take additional precautions before interacting with the multifunction tank access device 100. An oxygen sensor can be placed within the central housing 130 or vacuum relief module housing 150 to detect oxygen leakage through the vacuum relief valve 152. A methane detector sensor can be placed in close proximity to the vacuum relief port 154 to detect leakage of gases through the vacuum relief valve 152. One or more temperature sensors can be deployed inside and outside the multifunction tank access device 100 and configured to alert the operator to changes in the condition of the multifunction tank access device 100. The internal and external temperature readings can be used alone or in combination to identify or predict ingress or egress of gases from the storage tank 102 or the rapid increase in temperature caused by a combustion event.

The measurements produced by the various sensors within the multifunction tank access device 100 can be provided to a central control system 178 to provide operators with live, real-time information about the status and condition of the multifunction tank access device 100. The multifunction tank access device 100 can be integrated into a local edge computing network that includes a central control system 178. In other embodiments, the sensor output from the multifunction tank access device 100 is transmitted to a remote central control system 178 through wired or wireless networks using SCADA, MODBUS, or other conventional data transmission protocols.

As an example, the central control system 178 can be configured to identify trends of decreasing or increasing pressures measured by the internal pressure sensor 170. If the central control system 178 determines that the pressures are decreasing or increasing without the actuation of the pressure relieve valve 140 or the vacuum relief valve 152, the central control system 178 can alert the operator to the presence of an adverse event, such as a potential gas leak or the failure of the multifunction tank access device 100 to release accumulating pressure. This detection system permits the operator to take preemptive action to correct the situation to mitigate risks to the operator or the environment.

In some embodiments, the central control system 178 can be configured to use neural networks or machine learning to develop and refine a predictive correlation library 180 based on correlations between the empirical output from the various sensors within the multifunction tank access device 100 and the occurrence of adverse events at the multifunction tank access device 100 or storage tank 102. As an example, the correlation library 180 can be configured to predict the future occurrence of methane leaks, controlled gas exchange across the multifunction tank access device 100, or a combustion event based on empirical data produced by the sensors within or around the multifunction tank access device 100. The central control system 178 can be configured to apply a wide variety of comparative and statistical techniques, including, but not limited to, probability-density based usage indices, multivariate Hotelling T-squared distributions, association rule mining (ARM) algorithms, change point detection algorithms, and Bayesian and neural network-based anomaly detection and classification techniques.

Thus, upon its installation on the storage tank 102, the multifunction tank access device 100 performs most if not all of the necessary venting and vacuum control functions required for the safe operation of the storage tank 102. The multifunction tank access device 100 also eliminates the need for personnel to be exposed to potentially harmful environments by providing a vapor barrier when any repairs are needed to the upper assembly 116, as well as providing a vapor control valve 162 to permit the hermetically gauging and sampling of the contents of the storage tank 102. The multifunction tank access device 100 incorporates one or more sensors to alert the operator to concerning events or conditions and to inform the operator of potential valve malfunctions that indicate a need for valve redress or replacement. The multifunction tank access device 100 can be manufactured from a composite material that will melt in the presence of heat produced by a combustion event inside the storage tank 102. The multifunction tank access device 100 is thereby sacrificed to open the entire flow area of the thief hatch port for emergency fire venting.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A multifunction tank access device configured for connection to a storage tank capable of storing crude oil, wherein the storage tank has an opening for a conventional thief hatch, the multifunction tank access device comprising:
a lower assembly, wherein the lower assembly comprises an isolation valve; and
an upper assembly removably connected to the lower assembly, wherein the upper assembly comprises:
a central housing;
a pressure relief module;
a vacuum relief module; and
a tank access module.

2. The multifunction tank access device of claim 1, wherein the lower assembly further comprises a tank mounting flange that is configured to connect to the opening for the conventional thief hatch.

3. The multifunction tank access device of claim 1, wherein the pressure relief module comprises a pressure relief valve that is configured to open in response to a pressure inside the central housing that exceeds a setpoint pressure established for the pressure relief valve.

4. The multifunction tank access device of claim 3, wherein the pressure relief module further comprises a pressure relief port that vents excess pressure from the pressure relief valve.

5. The multifunction tank access device of claim 1, wherein the vacuum relief module comprises a vacuum relief valve that is configured to open in response to a vacuum inside the central housing.

6. The multifunction tank access device of claim 1, wherein the tank access module comprises a vapor control valve.

7. The multifunction tank access device of claim 6, wherein the vapor control valve comprises:
a closing valve;
a loading spool; and
a cap connected to the loading spool.

8. The multifunction tank access device of claim 1 further comprising an internal pressure sensor positioned within the central housing and configured to measure and report the pressure inside the central housing.

9. The multifunction tank access device of claim 1, wherein at least one of the central housing, the pressure relief module and the vacuum relief module is constructed from a material that melts at a temperature less than 450° F.

10. A multifunction tank access device configured for connection to a storage tank capable of storing crude oil, wherein the storage tank has an opening for a conventional thief hatch, the multifunction tank access device comprising:
a lower assembly that includes a tank mounting flange configured for attachment to the opening for the conventional thief hatch;
an upper assembly removably connected to the lower assembly, wherein the upper assembly comprises a central housing; and
wherein at least a portion of the multifunction tank access device is constructed from a material that melts at a temperature below 450° F.

11. The multifunction tank access device of claim 10, wherein the lower assembly further comprises an isolation valve.

12. The multifunction tank access device of claim 10, wherein the upper assembly further comprises:
a pressure relief module;
a vacuum relief module; and
a tank access module.

13. The multifunction tank access device of claim 12, wherein the pressure relief module comprises a pressure relief valve that is configured to open in response to a pressure inside the central housing that exceeds a setpoint pressure established for the pressure relief valve.

14. The multifunction tank access device of claim 13, wherein the pressure relief module further comprises a pressure relief port that vents excess pressure from the pressure relief valve.

15. The multifunction tank access device of claim 1, wherein the vacuum relief module comprises a vacuum relief valve that is configured to open in response to a vacuum inside the central housing.

16. The multifunction tank access device of claim 10, wherein the tank access module comprises a vapor control valve.

17. The multifunction tank access device of claim 16, wherein the vapor control valve comprises:
a closing valve;
a loading spool; and
a cap connected to the loading spool.

18. The multifunction tank access device of claim 10 further comprising an internal pressure sensor positioned within the central housing and configured to measure and report the pressure inside the central housing.

19. A multifunction tank access device configured for connection to a storage tank capable of storing crude oil, wherein the storage tank has an opening for a conventional thief hatch, the multifunction tank access device comprising:
a lower assembly, wherein the lower assembly comprises an isolation valve; and
an upper assembly removably connected to the lower assembly, wherein the upper assembly comprises:
a central housing;
a pressure relief module, wherein the pressure relief module comprises a pressure relief valve that is configured to open in response to a pressure inside the central housing that exceeds a setpoint pressure established for the pressure relief valve;
a vacuum relief module, wherein the vacuum relief module comprises a vacuum relief valve that is configured to open in response to a vacuum inside the central housing; and
a tank access module, wherein the tank access module comprises a vapor control valve.

20. The multifunction tank access device of claim 19, wherein at least one of the central housing, the pressure relief module and the vacuum relief module is constructed from a material that melts at a temperature less than 450° F.

21. A method for monitoring and predicting the occurrence of adverse events at a storage tank configured to store liquid and gaseous hydrocarbons, the method comprising the steps of:
providing a multifunction tank access device that includes one or more sensors, wherein each of the one or more sensors is configured to measure a condition in the multifunction tank access device or storage tank;
installing the multifunction tank access device on the storage tank in a manner that permits the multifunction tank access device to facilitate the exchange of gases into and out of the storage tank;
obtaining one or more condition measurements from the multifunction tank access device or storage tank with the one or more sensors;
providing the condition measurements to a central control system; and
alerting an operator to the presence or potential for an adverse event based on the condition measurements provided to the central control system.

22. The method of claim 21, wherein the step of providing a multifunction tank access device that includes one or more sensors further comprises providing a multifunction tank access device that includes one or more sensors selected from the group consisting of pressure sensors, temperature sensors, oxygen sensors and hydrocarbon sensors.

23. The method of claim 21, further comprising the step of establishing a correlation library based at least in part on the condition measurements.

24. The method of claim 23, further comprising the step of using machine learning to make correlations between the adverse events and the condition measurements.

25. The method of claim 24, where in the step of alerting an operator to the presence or potential for an adverse event further comprises alerting an operator to the prediction of an adverse event based on the condition measurements provided to the central control system.
